(19) United States
(12) Patent Application Publication
(10) Pub. No.: US 2006/0168069 A1
(43) Pub. Date: Jul. 27, 2006

(54) Method, system and program product for performing message benchmarking

(75) Inventors: Razeyah Stephen, Marlboro, MA (US); Richard A. Buck, Milford, MA (US); George Demetriou, Westford, MA (US); Michael J. Gagnon, Merrimack, NH (US); Russell L. Holden, Boxborough, MA (US); Harry R. Murray, Amherst, NH (US); Andrew K. Nolet, W. Nottingham, NH (US); James H. Powers, Haverhill, MA (US); Nirmala Venkatraman, Westford, MA (US)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/313,707

(22) Filed: Dec. 21, 2005

Related U.S. Application Data
(60) Provisional application No. 60/646,845, filed on Jan. 25, 2005.

(51) Int. Cl. G06F 15/16

(52) U.S. Cl. 709/206

(57) ABSTRACT

The present invention allows complex messaging configurations (e.g., server clusters) and messaging activities to be simulated in a single test. A server cluster having two or more mail servers is provided. Each server in the cluster is assigned one or more mail databases that are also replicated to the other servers in the cluster. Thus, each server has a copy of every mail database. Mail clients are then assigned to specific mail servers (e.g., 50% of the mail clients are assigned to mail server “1,” 50% of the mail clients are assigned to mail server “2”). The present invention will drive a messaging workload against the servers (in a single test) that will simulate the type of messaging activity that is typically experienced when the servers are in actual use within an organization or business.

### CROSS-REFERENCE TO RELATED APPLICATION

This application claims the benefit of co-pending provisional application Ser. No. 60/646,845, filed Jan. 25, 2005, the entire contents of which are herein incorporated by reference.

### BACKGROUND OF THE INVENTION

1. Field of the Invention

In general, the present invention provides a method, system and program product for performing message benchmarking. Specifically, the present invention provides a benchmark testing methodology that simulates complex configurations and messaging activities.

2. Related Art

Currently available messaging performance benchmarking tools only simulate simple mail load with messaging protocols such as Notes Remote Procedure Call (NRPC), which is Domino/Notes native mail and MAPI clients (Microsoft's proprietary mail transport protocol), plus most Internet protocols. A simple mail workload typically only simulates the sending and receiving of messages, and calendaring and scheduling activities usually with one messaging server or a simple clustering.

Currently, there are no available messaging performance benchmarking testing systems that can simulate complex configurations and messaging activities that typical businesses deploy for messaging in their enterprise all in the same test. For example, Microsoft Exchange Server Load Simulator (LoadSim) 2003 is a benchmarking tool to simulate the performance load of MAPI clients. LoadSim allows you to test how a server running Exchange 2003 responds to electronic mail loads. To simulate the delivery of these messaging requests, LoadSim tests are run on client computers. These tests send multiple messaging requests to the Exchange server, thereby causing a simple mail load. However, such a load is not typical of that commonly experienced by businesses or organizations. As such, the simple load is not an accurate way to test a mail system

The Exchange Stress and Performance Tool (ESP) is a highly scalable stress and performance utility for Exchange. It simulates large numbers of client sessions by concurrently accessing one or more protocol servers. Unfortunately, both the ESP and LoadSim workload simulation tools only simulate a simple messaging testing methodology. Neither provides a complex message benchmarking workload that includes simple mail with the addition elements of clustering with active multiple messaging servers and complex messaging activities all in the same workload.

In view of the foregoing, there exists a need for a method, system and program product for performing message benchmarking. Specifically, a need exists for a testing methodology that is capable of simulating complex configurations (e.g., clusters) as well as messaging activities all in a single test.

### SUMMARY OF THE INVENTION

In general, the present invention provides a method, system and program product for performing message benchmarking. Specifically, the present invention allows complex messaging configurations (e.g., server clusters) and messaging activities to be simulated in a single test. A server cluster having two or more mail servers is provided. Each server in the cluster is assigned one or more mail databases that are also replicated to the other servers in the cluster. Thus, each server has a copy of every mail database. Mail clients are then assigned to specific mail servers (e.g., 50% of the mail clients are assigned to mail server “1,” 50% of the mail clients are assigned to mail server “2”). The present invention will drive a messaging workload against the servers (in a single test) that will simulate the type of messaging activity that is typically experienced when the servers are in actual use within an organization or business. Such messaging activities include, for example, client mail activity (e.g., sending, reading, deleting messages, etc.), replication of any changes made to local copies of mail files stored on mail clients to the mail servers, replication of any changes made to the mail file and/or databases as recorded on one of the mail servers to the other mail servers, mail folder view updates, and full text index searches, etc. Thus, the present invention provides a testing methodology that is truly representative of what a business or organization would typically experience.

A first aspect of the present invention provides a method for performing message benchmarking, comprising: providing a cluster of mail servers, wherein each of the mail servers is assigned a set of mail databases, and wherein each mail database assigned to the mail servers is replicated to the other mail servers in the cluster; and driving a messaging workload against the cluster of mail servers, wherein the messaging workload simulates at least one messaging activity selected from the group consisting of client mail activity, replication of any changes made to local copies of mail files stored on mail clients to the mail servers, replication of any changes made to the mail databases as recorded on one of the mail servers to the other mail servers, mail folder view updates, and full text index searches.

A second aspect of the present invention provides a system for performing message benchmarking, comprising: means for driving a messaging workload against a cluster of mail servers, wherein each of the mail servers is assigned a set of mail databases, wherein each mail database assigned to the mail servers is replicated to the other mail servers in the cluster, and wherein the messaging workload simulates at least one messaging activity selected from the group consisting of client mail activity, replication of any changes made to local copies of mail files stored on mail clients to the mail servers, replication of any changes made to the mail databases as recorded on one of the mail servers to the other mail servers, mail folder view updates, and full text index searches; and means for monitoring responses of the mail servers to the messaging workload.

A third aspect of the present invention provides a program product stored on a computer readable medium for performing message benchmarking, the computer readable medium comprising program code for performing the following steps: driving a messaging workload against a cluster of mail servers, wherein each of the mail servers is assigned a set of mail databases, wherein each mail database assigned to the mail servers is replicated to the other mail servers in the cluster, and wherein the messaging workload simulates at least one messaging activity selected from the group consisting of client mail activity, replication of any changes made to local copies of mail files stored on mail clients to the mail servers, replication of any changes made to the mail databases as recorded on one of the mail servers to the other mail servers, mail folder view updates, and full text index searches; and monitoring responses of the mail servers to the messaging workload.

A fourth aspect of the present invention provides a method for deploying an application for performing message benchmarking, comprising: providing a computer infrastructure being operable to: drive a messaging workload against a cluster of mail servers, wherein each of the mail servers is assigned a set of mail databases, wherein each mail database assigned to the mail servers is replicated to the other mail servers in the cluster, and wherein the messaging workload simulates at least one messaging activity selected from the group consisting of client mail activity, replication of any changes made to local copies of mail files stored on mail clients to the mail servers, replication of any changes made to the mail databases as recorded on one of the mail servers to the other mail servers, mail folder view updates, and full text index searches; and monitor responses of the mail servers to the messaging workload.

A fifth aspect of the present invention provides computer software embodied in a propagated signal for performing message benchmarking, the computer software comprising instructions to cause a computer system to perform the following: drive a messaging workload against a cluster of mail servers, wherein each of the mail servers is assigned a set of mail databases, wherein each mail database assigned to the mail servers is replicated to the other mail servers in the cluster, and wherein the messaging workload simulates at least one messaging activity selected from the group consisting of client mail activity, replication of any changes made to local copies of mail files stored on mail clients to the mail servers, replication of any changes made to the mail databases as recorded on one of the mail servers to the other mail servers, mail folder view updates, and full text index searches; and monitor responses of the mail servers to the messaging workload.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an environment for which message benchmarking will be performed according to the present invention.

FIG. 2 depicts a computer system that will simulate a messaging workload according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE DRAWINGS

As indicated above, the present invention provides a method, system and program product for performing message benchmarking. Specifically, the present invention allows complex messaging configurations (e.g., server clusters) and messaging activities to be simulated in a single test. A server cluster having two or more mail servers is provided. Each server in the cluster is assigned one or more mail databases that are also replicated to the other servers in the cluster. Thus, each server has a copy of every mail database. Mail clients are then assigned to specific mail servers (e.g., 50% of the mail clients are assigned to mail server “1,” 50% of the mail clients are assigned to mail server “2”). The present invention will drive a messaging workload against the servers (in a single test) that will simulate the type of messaging activity that is typically experienced when the servers are in actual use within an organization or business. Such messaging activities include, for example, client mail activity (e.g., sending, reading, deleting messages, etc.), replication of any changes made to local copies of mail files stored on mail clients to the mail servers, replication of any changes made to the mail files and/or databases as recorded on one of the mail servers to the other mail servers, mail folder view updates, and full text index searches, etc. Thus, the present invention provides a testing methodology that is truly representative of what a business or organization would typically experience.

The complex clustering implemented under the present invention supports multiple messaging servers with mail files on different servers, cluster failover and load balancing. This solution can be implemented for various protocols such as HTTP, NRPC, IMAP etc.

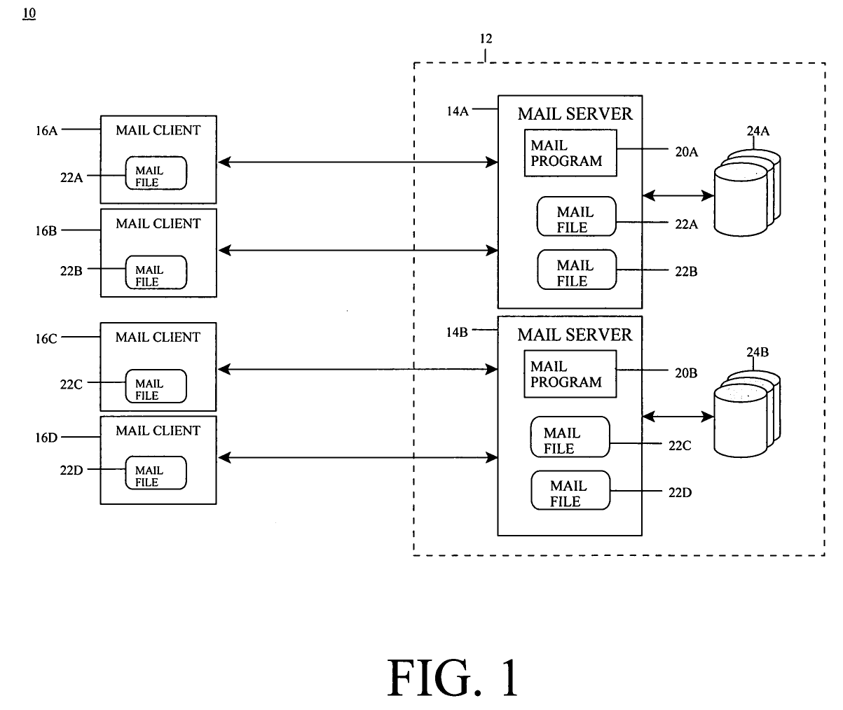

Referring now to FIG. 1, an environment 10 is shown for which message benchmarking will be performed/simulated according to the present invention. As depicted, environment 10 shows server cluster 12 having mail servers 14A-B in communication with mail clients 16A-D. It should be understood that two mail servers 16A-B and four mail clients 18A-B are shown for illustrative purposes only. That is, the teachings recited herein could be carried out in conjunction with any quantity of mail servers and/or mail clients. In addition, the terms “message” and “messaging” as used herein is intended to refer to electronic mail messages and the like.

In any event, each mail server 14A-B is assigned a set (one or more) of mail databases 24A-B. Under the present invention, each mail database assigned to a particular mail server will be replicated to the other mail servers in cluster 12. Accordingly, mail databases 24A are replicated to mail server 14B, and mail databases 24B are replicated to mail server 14A. Shown loaded on mail servers 14A-B are mail programs 20A-B and mail files 22A-D. Mail programs 20A-B are intended to represent any type of electronic mail server programs (e.g., Lotus Notes, which is commercially available from International Business Machines Corp. of Armonk, N.Y.). Mail files 22A-B typically correspond to mail clients 16A-D and can be stored in mail databases 24A-B. For example, mail file 22A is that which hold messages for mail client 16A. Under the present invention some or all of mail files 22A-D can be replicated to mail clients 16A-D for local storage (all are shown as having been replicated in FIG. 1, although this need not be the case). As will be further explained below, the present invention drives a workload against cluster 12, which among other things, simulates changes made to mail files 22A-D on mail clients 16A-D, the replication of such changes to the respective mail servers 14A-B, as well as the replication of such changes between mail servers 14A-B.

As further shown, mail clients 16A-D are assigned to particular mail servers 14A-B. For example, mail clients 16A-B are assigned to mail server 14A, while mail clients 16C-D are assigned to mail server 14B. In addition, the present invention allows the mail servers to be set up in a “round-robin” fashion (i.e., client/user home mail server) such as the following:

mail1, mail3, mail5, . . . server1

mail2, mail4, mail6, . . . server2

A “home mail server” is the primary server where mail clients/users have their mail files. Being able to specify and simulate this split is can be used for load balancing among cluster 12 (mail servers 14A-B).

As mentioned above, the present invention performs message benchmarking by driving a messaging workload against mail servers 14A-B of cluster 12 such that real-life messaging activity is simulated.

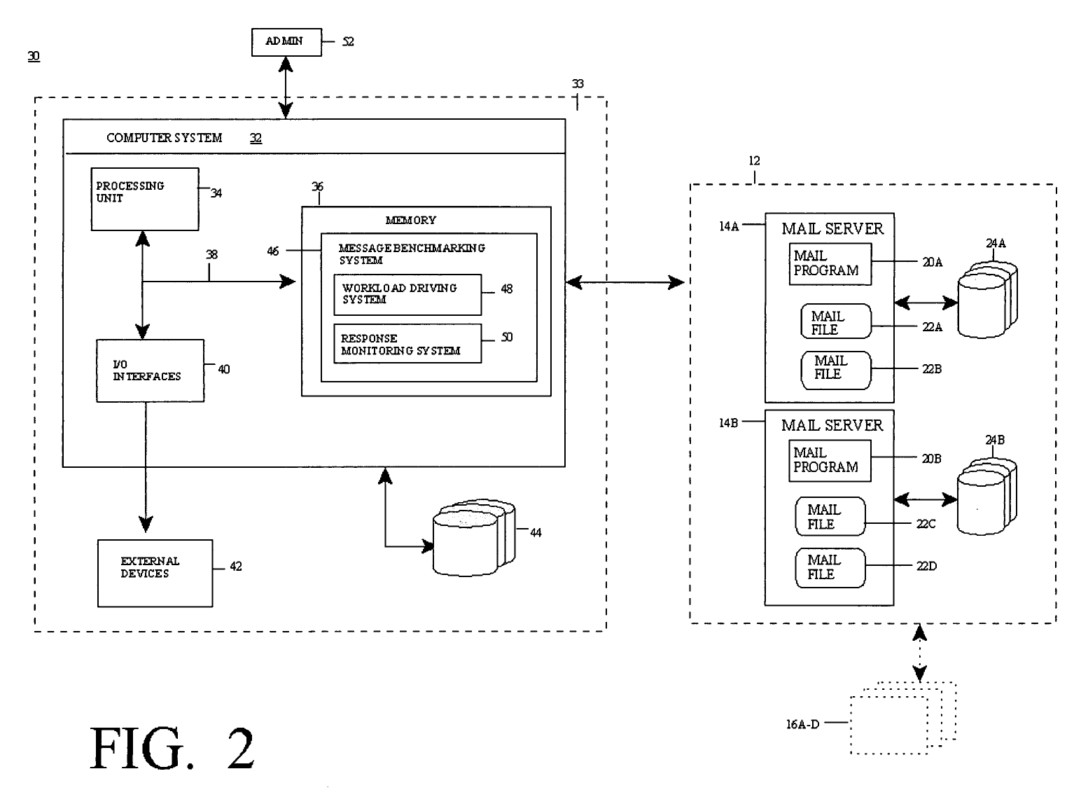

Referring to FIG. 2, a system 30 for performing such message benchmarking is shown. Under system 30, a computer system 32 will drive the messaging workload against mail servers 14A-B in cluster 12, and monitor the responses thereof. Computer system 32 is intended to represent any type of computer system capable of carrying out the teachings of the present invention. For example, computer system 32 could be a laptop computer, a desktop computer, a workstation, a handheld device, etc. Moreover, communications between computer system 32 and mail servers 14A-B can occur over one or more networks. Such a network can comprise any combination of various types of communications links. For example, the network can comprise addressable connections that may utilize any combination of wired and/or wireless transmission methods. Further, the network can comprise one or more of any type of network, including the Internet, a wide area network (WAN), a local area network (LAN), a virtual private network (VPN), etc. Where communications occur via the Internet, connectivity could be provided by conventional TCP/IP sockets-based protocol, and a computing device could utilize an Internet service provider to establish connectivity to the Internet.

It should be understood that one or more aspects of the present invention such as computer system 32 could be deployed within a computer infrastructure 33. This is intended to demonstrate, among other things, that some or all of the components of system 30 could be deployed, managed, serviced, etc. by a service provider who offers to perform message benchmarking.

In any event, under the present invention, message benchmarking will be performed using message benchmarking system 46, which is shown implemented on computer system 32 as computer program code. To this extent, computer system 32 is shown including a processing unit 34, a memory 36, a bus 38, and input/output (I/O) interfaces 40. Further, computer system 32 is shown in communication with external I/O devices/resources 42 and a storage system 44. In general, processing unit 34 executes computer program code, such as message benchmarking system 46, which is stored in memory 36 and/or storage system 44. While executing computer program code, processing unit 34 can read and/or write data, to/from memory 36, storage system 44, and/or I/O interfaces 40. Bus 38 provides a communication link between the components in computer system 32. External devices 42 can comprise any device (e.g., keyboard, pointing device, display, etc.) that enables a user to interact with computer system 32 and/or any device (e.g., network card, modem, etc.) that enables computer system 32 to communicate with one or more other computing devices.

Computer system 32 is only representative of various possible computer infrastructures that can include numerous combinations of hardware. For example, processing unit 34 may comprise a single processing unit, or be distributed across one or more processing units in one or more locations, e.g., on a client and server. Similarly, memory 36 and/or storage system 44 can comprise any combination of various types of data storage and/or transmission media that reside at one or more physical locations. Further, I/O interfaces 40 can comprise any system for exchanging information with one or more external devices 42. Still further, it is understood that one or more additional components (e.g., system software, math co-processing unit, etc.) not shown in FIG. 2 can be included in computer system 32. Moreover, if computer system 32 comprises a handheld device or the like, it is understood that one or more external devices 42 (e.g., a display) and/or storage system 44 could be contained within computer system 32, not externally as shown.

Storage system 44 and mail databases 24A-B can be any type of systems capable of providing storage for information under the present invention. As such, storage system 44 and mail databases 24A-B could include one or more storage devices, such as a magnetic disk drive or an optical disk drive. In another embodiment, storage system 44 and mail databases 24A-B includes data distributed across, for example, a local area network (LAN), wide area network (WAN) or a storage area network (SAN) (not shown). Although not shown, additional components, such as cache memory, communication systems, system software, etc., may be incorporated into computer system 32.

Shown in memory 36 of computer system 32 is message benchmarking system 46, which includes workload driving system 48 and response monitoring system 50. It is understood that some of the various systems shown in FIG. 2 can be implemented independently, combined, and/or stored in memory for one or more separate computers systems 32 that communicate over a network. Further, it is understood that some of the systems/functionality may not be implemented and/or additional systems/functionality may be included as part of the present invention. Still yet, it is understood that the functionality that will be described for each of these systems can be represented with a different configuration. That is, the functionality thereof can be combined into a single system, or broken down into addition systems.

In any event, workload driving system 48 will drive a workload against mail servers 14A-B that will simulate the type of messaging activity that is typically experienced when the servers are in actual use within an organization or business. Mail clients 16A-D are shown in phantom in FIG. 2 to indicate that they will be simulated by workload driving system 48 as if they are actually interacting with mail servers 14A-B.

Under the present invention, the messaging workload driven against mail servers 14A-B include messaging activities such as, for example, client mail activity (e.g., sending, reading, deleting, and moving messages, sending meeting invitations, responding to invitations, etc. on mail clients 16A-D), replication of any changes made to local copies of mail files 22A-D (FIG. 1) stored on mail clients 16A-D to the mail servers, replication of any changes made to the mail file and/or databases as recorded on one of the mail servers to the other mail servers, mail folder view updates, and full text index searches, etc.

More specifically, the workload driving against mail servers 14A-B will simulate client mail activity such as those shown above. It will also simulate the replication that can occur between mail clients 16A-D and mail servers 14A-B, as well as the replication that occurs between mail servers 14A-B. For example, the workload could simulate the changing of a local mail file on a mail client 16A, the replication of such changing to mail server 14A, and the subsequent replication of that change to mail servers 14B (because any changes recorded on a mail server will be replicated to all other mail servers (i.e., to the appropriate mail databases) in cluster 12). The messaging workload of the present invention also simulates various server-based activities such as mail folder view updates, and full text index searches, etc. Similar to the client-based messaging activities, should any server-based activity result in changes to a mail file or database on a mail server, such changes will be replicated to the other mail servers (databases) in cluster 12.

Providing support for full text index searching generally corresponds to a full-text search of two or more terms. To this extent, mail databases 24A-B (FIG. 1) should be full-text indexed (FTI). A software agent can be provided (e.g., on mail servers 14A-B, on computer system 32, etc.) to create the FTI for the mail databases 24A-B. This agent can be changed to specify: (a) the range of databases to be processed; and (b) the scheduled date/time for the agent to be run on the mail servers 14A-B (one-time run). Note: this agent can be used in a partitioned environment. One or more copies can be made on each individual mail server 14A-B to process separate mail database ranges.

Under the present invention, workload driving system 48 will drive the messaging workload in a single test. As this test is being performed, response monitoring system 50 will monitor and record the responses of mail servers 14A-B. These responses can then be presented to administrator 52 for review.

It should be understood that the examples of messaging activities recited here are not intended to be exhaustive and that the present invention can simulate any type of messaging activity now known or later developed. While shown and described herein as a method and system for performing message benchmarking, it is understood that the invention further provides various alternative embodiments. For example, in one embodiment, the invention provides a computer-readable/useable medium that includes computer program code to enable a computer infrastructure to perform message benchmarking. To this extent, the computer-readable/useable medium includes program code that implements each of the various process steps of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 36 (FIG. 2) and/or storage system(s) 44 (FIG. 2) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process steps of the invention on a subscription, advertising, and/or fee basis. That is, a service provider, such as a Solution Integrator, could offer to perform message benchmarking. In this case, the service provider can create, maintain, support, etc., a computer infrastructure, such as computer infrastructure 33 (FIG. 2) that performs the process steps of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for performing message benchmarking. In this case, a computer infrastructure, such as computer infrastructure 33 (FIG. 2), can be provided and one or more systems for performing the process steps of the invention can be obtained (e.g., created, purchased, used, modified, etc.) and deployed to the computer infrastructure. To this extent, the deployment of a system can comprise one or more of (1) installing program code on a computing device, such as computer system 32 (FIG. 2), from a computer-readable medium; (2) adding one or more computing devices to the computer infrastructure; and (3) incorporating and/or modifying one or more existing systems of the computer infrastructure to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A method for performing message benchmarking, comprising:
providing a cluster of mail servers, wherein each of the mail servers is assigned a set of mail databases, and wherein each mail database assigned to the mail servers is replicated to the other mail servers in the cluster; and
driving a messaging workload against the cluster of mail servers, wherein the messaging workload simulates at least one messaging activity selected from the group consisting of client mail activity, replication of any changes made to local copies of mail files stored on mail clients to the mail servers, replication of any changes made to the mail databases as recorded on one of the mail servers to the other mail servers, mail folder view updates, and full text index searches.

2. The method of claim 1, further comprising assigning the mail clients to specific mail servers in the cluster.

3. The method of claim 1, wherein the messaging workload comprises a single messaging workload.

4. The method of claim 1, wherein the client mail activity comprises at least one activity selected from the group consisting of opening mail files, sending messages, deleting messages, reading messages, moving messages, sending invitations, and responding to invitations.

5. The method of claim 1, further comprising the step of providing the mail clients with a local copy of their respective mail files, prior to the driving step.

6. A system for performing message benchmarking, comprising:
means for driving a messaging workload against a cluster of mail servers, wherein each of the mail servers is assigned a set of mail databases, wherein each mail database assigned to the mail servers is replicated to the other mail servers in the cluster, and wherein the messaging workload simulates at least one messaging activity selected from the group consisting of client mail activity, replication of any changes made to local copies of mail files stored on mail clients to the mail servers, replication of any changes made to the mail databases as recorded on one of the mail servers to the other mail servers, mail folder view updates, and full text index searches; and
means for monitoring responses of the mail servers to the messaging workload.

7. The system of claim 6, wherein the mail clients are assigned to specific mail servers in the cluster.

8. The system of claim 6, wherein the messaging workload comprises a single messaging workload.

9. The system of claim 6, wherein the client mail activity comprises at least one activity selected from the group consisting of opening mail files, sending messages, deleting messages, reading messages, moving messages, sending invitations, and responding to invitations.

10. The system of claim 6, wherein the mail clients are provided with a local copy of their respective mail files, prior to the driving step.

11. A program product stored on a computer readable medium for performing message benchmarking, the computer readable medium comprising program code for performing the following steps:
driving a messaging workload against a cluster of mail servers, wherein each of the mail servers is assigned a set of mail databases, wherein each mail database assigned to the mail servers is replicated to the other mail servers in the cluster, and wherein the messaging workload simulates at least one messaging activity selected from the group consisting of client mail activity, replication of any changes made to local copies of mail files stored on mail clients to the mail servers, replication of any changes made to the mail databases as recorded on one of the mail servers to the other mail servers, mail folder view updates, and full text index searches; and
monitoring responses of the mail servers to the messaging workload.

12. The program product of claim 11, wherein the mail clients are assigned to specific mail servers in the cluster.

13. The program product of claim 11, wherein the messaging workload comprises a single messaging workload.

14. The program product of claim 11, wherein the client mail activity comprises at least one activity selected from the group consisting of opening mail files, sending messages, deleting messages, reading messages, moving messages, sending invitations, and responding to invitations.

15. The program product of claim 11, wherein the mail clients are provided with a local copy of their respective mail files, prior to the driving step.

16. A method for deploying an application for performing message benchmarking, comprising:
providing a computer infrastructure being operable to:
drive a messaging workload against a cluster of mail servers, wherein each of the mail servers is assigned a set of mail databases, wherein each mail database assigned to the mail servers is replicated to the other mail servers in the cluster, and wherein the messaging workload simulates at least one messaging activity selected from the group consisting of client mail activity, replication of any changes made to local copies of mail files stored on mail clients to the mail servers, replication of any changes made to the mail databases as recorded on one of the mail servers to the other mail servers, mail folder view updates, and full text index searches; and
monitor responses of the mail servers to the messaging workload.

17. The method of claim 16, wherein the mail clients are assigned to specific mail servers in the cluster.

18. The method of claim 16, wherein the messaging workload comprises a single messaging workload.

19. The method of claim 16, wherein the client mail activity comprises at least one activity selected from the group consisting of opening mail files, sending messages, deleting messages, reading messages, moving messages, sending invitations, and responding to invitations.

20. The method of claim 16, wherein the mail clients are provided with a local copy of their respective mail files, prior to the driving step.
